(19) United States
(12) Patent Application Publication
(10) Pub. No.: US 2024/0020391 A1
(43) Pub. Date: Jan. 18, 2024

(54) LOG-BASED VULNERABILITIES DETECTION AT RUNTIME

(71) Applicant: VMWARE, INC., Palo Alto, CA (US)

(72) Inventors: Chandrashekhar JHA, Bangalore (IN); Hemani KATYAL, Bangalore (IN); Yash BHATNAGAR, Bangalore (IN); Akash SRIVASTAVA, Bangalore (IN); Pranita MORISETTY, Bangalore (IN)

(21) Appl. No.: 17/958,277

(22) Filed: Sep. 30, 2022

(30) Foreign Application Priority Data
Jul. 14, 2022 (IN) 202241040488

(51) Int. Cl. G06F 21/57

(52) U.S. Cl. CPC G06F 21/577; G06F 2221/033

(57) ABSTRACT

In an example, a computer-implemented method may include receiving, during runtime, a plurality of logs of a network activity associated with compute nodes of a protected network. Further, the method may include extracting a vulnerability signature of an attack based on the plurality of logs. Furthermore, the method may include validating the vulnerability signature of the attack by correlating the vulnerability signature with available data on a first public database. Upon validating the vulnerability signature, the method may include retrieving vulnerability information associated with the vulnerability signature from the first public database or a second public database. Further, the method may include presenting the vulnerability information associated with the vulnerability signature on a graphical user interface.

### RELATED APPLICATIONS

Benefit is claimed under 35 U.S.C. 119(a)-(d) to Foreign Application Serial No. 202241040488 filed in India entitled “LOG-BASED VULNERABILITIES DETECTION AT RUNTIME”, on Jul. 14, 2022, by VMware, Inc., which is herein incorporated in its entirety by reference for all purposes.

### TECHNICAL FIELD

The present disclosure relates to detecting security vulnerabilities in computing environments, and more particularly to methods, techniques, and systems for detecting runtime security vulnerabilities in the computing environments based on log data.

### BACKGROUND

In recent years, security vulnerabilities in products and/or services have been attacked by ever-changing security attacks (e.g., malware, ransomware, and the like) that present constant, new threats to the security of computing devices. Such security attacks have caused data corruption, allowed access to and/or the conversion of otherwise prohibited content, information, privileges, and the like, caused disclosure of private information, caused monetary loss, caused reputational damage, and the like. Often, the security vulnerabilities affect both product/service providers and consumers of vulnerable products and/or services. Service providers and consumers are frequently concerned whether they are susceptible to security vulnerabilities of their products and/or services. Accordingly, constant effort is made to keep pace with the ever-increasing number and variety of security attacks.

### BRIEF DESCRIPTION OF THE DRAWINGS

FIG. 1A is a block diagram of an example system, depicting a log management server to detect vulnerabilities based on logs;

FIG. 1B is a block diagram of the example system of FIG. 1A, depicting additional features;

FIG. 2 is a flow diagram illustrating an example computer-implemented method for detecting vulnerabilities in compute nodes of a protected network;

FIG. 3 is a flow diagram illustrating another example method for detecting security vulnerabilities in compute nodes;

FIG. 4A is graphical user interface, depicting example logs obtained corresponding to a period;

FIG. 4B shows an example regular expression to extract the logs including vulnerability signatures;

FIG. 4C depicts an example list of filtered logs including the vulnerability signatures;

FIG. 5A is an example graphical user interface depicting vulnerability by severity and type;

FIG. 5B is another example graphical user interface depicting common vulnerabilities and exposures (CVE) details for various system vulnerabilities;

FIG. 5C is yet another example graphical user interface depicting access exploitation and impact of vulnerability along with potential fixes; and

FIG. 6 is a block diagram of an example log management server including non-transitory computer-readable storage medium storing instructions to detect vulnerabilities in a computing environment.

The drawings described herein are for illustrative purposes and are not intended to limit the scope of the present subject matter in any way.

### DETAILED DESCRIPTION

Examples described herein may provide an enhanced computer-based and/or network-based method, technique, and system to detect runtime security vulnerabilities in a computing environment based on log data. The paragraphs [0016] to [0021] present an overview of the computing environment, existing methods to detect vulnerabilities in the computing environment, and drawbacks associated with the existing methods.

Computing environment may be a physical computing environment (e.g., an on-premise enterprise computing environment or a physical data center) and/or virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. Example virtual computing environment may include different compute nodes (e.g., physical computers, virtual machines, and/or containers). Further, the computing environment may include multiple application hosts (i.e., physical computers) executing different workloads such as virtual machines, containers, and the like running therein. Each compute node may execute different types of applications and/or operating systems.

Computing resources are physical/virtual computing devices and/or software applications; any or all of which may be offered as a product and/or a service. Example resources may include, virtual machines (VMs), software appliances, management agents (e.g., a Common Information Management (CIM) agent, a Simple Network Management Protocol (SNMP) agent, and/or a configuration management agent), cloud services, mobile agents (e.g., mobile software application code and a corresponding application state), and/or business services (e.g., Information Technology Infrastructure library services).

Computing resources are susceptible to security vulnerabilities or attacks, such as denial of service, privilege elevation, directory traversal, buffer overflow, unauthorized remote or local execution/access, information leakage, and the like. Such attacks can be particularly damaging and costly for enterprises such as corporations, governments, and other organizations. A vulnerability may refer to a weakness or flaw in software, hardware, or firmware of a compute node. Such weakness might allow an adversary to violate the confidentiality, the availability, and the integrity of a computing system (e.g., a compute node), and its processes/applications. In network security, vulnerability may refer to the weakness of a compute node that could allow unauthorized intrusion in a network of the computing environment. Security vulnerabilities are problematic as they may lead to unrestricted access to prohibited information.

Every year, the organisations lose a significant amount of money (e.g., millions of dollars) in security breaches. In this regard, software providers or vendors (e.g., VMware®, Microsoft®, and the like) may regularly issue public warning and advisories to their users about newly discovered vulnerabilities in their software products (e.g., vCenter, virtual storage area network (vSAN), Microsoft Windows, Microsoft Office software, and the like). However, despite the information, the users are either not aware or do not take the necessary actions to remediate the vulnerabilities.

In other examples, online tools such as Appcheck, Nessus, Coverity, and the like can help detect the vulnerabilities in an application. Such tools may detect the vulnerabilities by scanning the complete code of the application or the libraries at compile time. However, the problem with this approach is that software products like vCenter, vSAN, operating systems like Microsoft Windows, Linux or even frameworks are significantly large and complex that it is often not feasible to perform a holistically complete scan on a periodic basis. Also, all the vulnerabilities cannot be detected by scanning the code of the application. Thus, limiting the usability of the tools.

In other examples, to keep the users safe from the vulnerabilities, the software vendors may publish these vulnerabilities in logs. These vulnerabilities are generated at runtime through logs of the application. The software vendors may publish public warnings and advisories along with remedies and fixes for the newly discovered vulnerabilities in the products. To further reinforce awareness about these vulnerabilities, the software vendors also publish warning logs in the software products. However, despite these warnings and public advisories published by the software vendors, some users may be ignorant of these vulnerabilities in their systems and hence vulnerable to security breaches.

Examples described herein may provide a log management server to detect vulnerabilities in a product by correlating logs with security signatures published in public sources. The log management server may receive, during runtime, a plurality of logs associated with a plurality of applications or operating systems running in a computing environment via a log database. Further, the log management server may extract a vulnerability signature of an attack based on the plurality of logs. Furthermore, the log management server may validate the vulnerability signature of the attack by correlating the vulnerability signature with available data on a public database. Upon validating the vulnerability signature, the log management server may retrieve vulnerability information associated with the vulnerability signature from the public database. Further, the log management server may generate an insight by curating the vulnerability information associated with the vulnerability signature and present the insight on a graphical user device. Thus, examples described herein may provide a complete visibility of the runtime security vulnerabilities to the users in the form of a comprehensive dashboard, for instance. where the users can view, understand, and take actions to fix the vulnerabilities based on recommendations.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

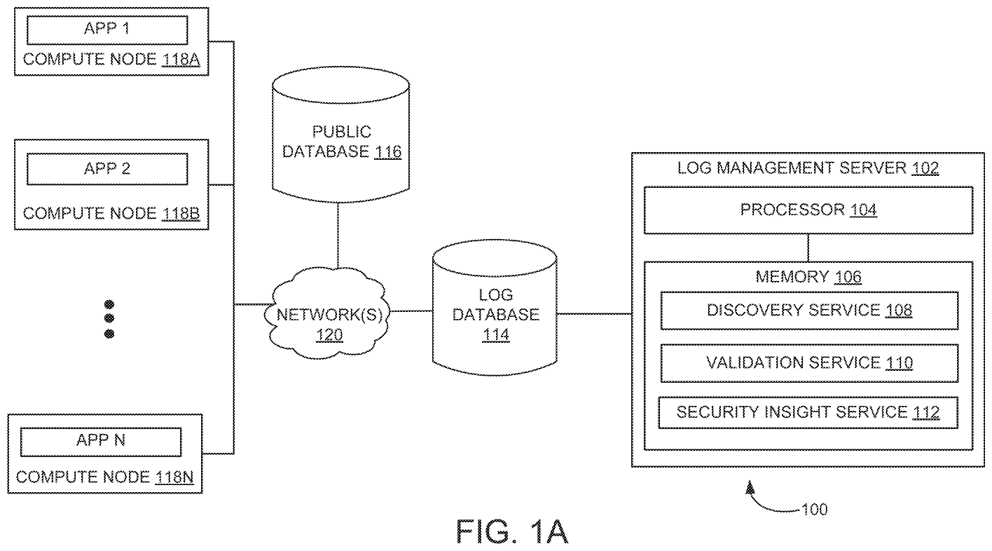

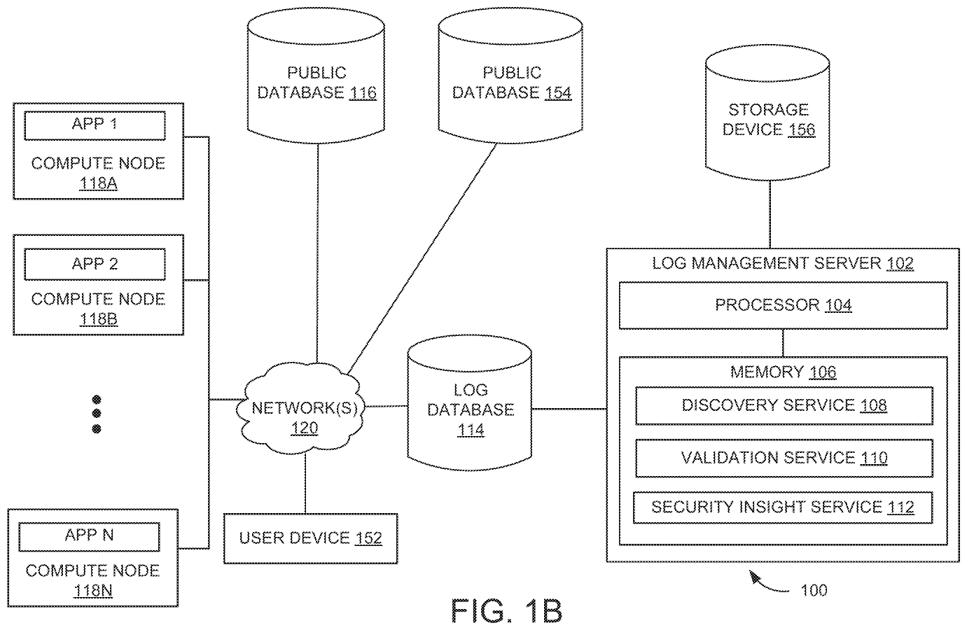

FIG. 1A is a block diagram of an example computing environment 100, depicting a log management server 102 to detect vulnerabilities based on logs. Example computing environment 100 may be a networked computing environment such as an enterprise computing environment, a cloud computing environment, a virtualized environment, a cross-cloud computing environment, or the like. An example cloud computing environment is VMware vSphere®. As shown in FIG. 1A, computing environment 100 may include multiple compute nodes 118A-118N and log management server 102 that is in communication with compute nodes 118A-118N over one or more networks 120.

Example compute nodes 118A-118N may include, but not limited to, physical computing devices, virtual machines, containers, or the like. The virtual machines, in some embodiments, may operate with their own guest operating systems on a physical computing device using resources of the physical computing device virtualized by virtualization software (e.g., a hypervisor, a virtual machine monitor, and the like). A container is a data computer node that runs on top of a host operating system without the need for a hypervisor or separate operating system. Log management server 102 may refer to a computing device or computer program (i.e., executing on a computing device) that provides some service to compute nodes 118A-118N or applications (e.g., app 1 to app N) executing on compute nodes 118A-118N. Compute nodes 118A-118N and log management server 102 may communicate over communication links (e.g., networks 120). Communication is according to a protocol, which may be a message-based protocol.

Example network 120 can be a managed Internet protocol (IP) network administered by a service provider. For example, network 120 may be implemented using wireless protocols and technologies, such as Wi-Fi, WiMAX, and the like. In other examples, network 120 can also be a packet-switched network such as a local area network, wide area network, metropolitan area network, Internet network, or other similar type of network environment. In yet other examples, network 120 may be a fixed wireless network, a wireless local area network (LAN), a wireless wide area network (WAN), a personal area network (PAN), a virtual private network (VPN), intranet or other suitable network system and includes equipment for receiving and transmitting signals. Network 120 can also have a hard-wired connection to compute nodes 118A-118N.

In some examples, each of compute nodes 118A-118N may include a processing resource/processor and memory. Example processor can be custom made or commercially available processor, a central processing unit (CPU), an auxiliary processor among several processors associated with compute nodes 118A-118N, a semiconductor-based microprocessor (in the form of a microchip or chip set, for example), a macro processor, or generally any device for executing computer-readable program code (e.g., a software product such as an application, a cloud service, an operating system, a system component, or the like). Example memory may be a computer-readable storage medium. In some examples, memory can have a distributed architecture, where various components are situated remote from one another, but can be accessed by compute nodes 118A-118N. Processors may be configured to execute software stored within associated one of memories, to communicate data to and from the memory, and to generally control operations of compute nodes 118A-118N pursuant to the computer-readable program code. Example non-transitory computer readable medium is an electronic, magnetic, optical, or other physical device or means that can contain or store a computer program for use by or in connection with a computer related system. The computer-readable program code in the non-transitory computer-readable medium may include one or more separate programs and may be in the form of a source program, executable program (object code), script, or any other entity comprising a set of instructions to be performed.

Examples described in FIG. 1A may depict log management server 102 in communication with compute nodes 118A-118N, however, in some examples, a group of log management servers or a cluster of log management servers can communicate with multiple compute nodes 118A-118N over one or more networks 120 to provide services to compute nodes 118A-118N. Further, numerous types of applications may be supported on computing environment 100. For example, computing environment 100 may include a plurality of applications (i.e., app 1 to app N) running on corresponding compute nodes 118A-118N.

Such computer programs or software products (e.g., applications and/or operating systems) may be susceptible to security vulnerabilities. A software vulnerability may refer to a weakness or flaw in software code (e.g., a software product) that can impact software performance and security. The software vulnerability may allow an attacker to gain control of a compute node. Such defects can be because of the way the software is designed, or because of a flaw in the way that the software is coded.

Further, the computer programs or software products may generate logs, i.e., files that contains information about events that have occurred within a software application. In some examples, the applications (i.e., app 1, app 2, and the like) may generate application logs including information about events or activities performed by the applications to facilitate technical support and troubleshooting of the applications. Further, the application logs may include service logs associated with corresponding services. For example, the application logs may include short messages, the source of the records, timestamps of the events, log levels (e.g., fatal, error, warning, info, debug, trace, and the like) specifying the importance of the records, and/or the like. In other examples, the application logs may include a detailed sequence of statements that describe the events occurred during an operation of the application such as errors, exceptions, anomalies, and the like. Further, the application logs may be saved in a log database 114. Similarly, operating system may generate operating system logs for storing in log database 114. Thus, log database 114 may collect log data from compute nodes 118A-118N that log management server 102 (e.g., vRealize Log Insight) can ingest and analyze.

As shown in FIG. 1A, log management server 102 may execute centralized management services that may be interconnected to manage the resources centrally in computing environment 100. Example centralized management service may be enabled by vRealize Log Insight Cloud, which is VMware's cloud monitoring platform. In an example, log management server 102 may be communicatively connected to compute nodes 118A-118N and different databases (e.g., log database 114, a public database 116, and the like) via network 120.

Further, log management server 102 includes a processor 104. Processor 104 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein. Furthermore, log management server 102 includes memory 106 coupled to processor 104. Example memory 106 includes a discovery service 108, a validation service 110, and a security insight service 112.

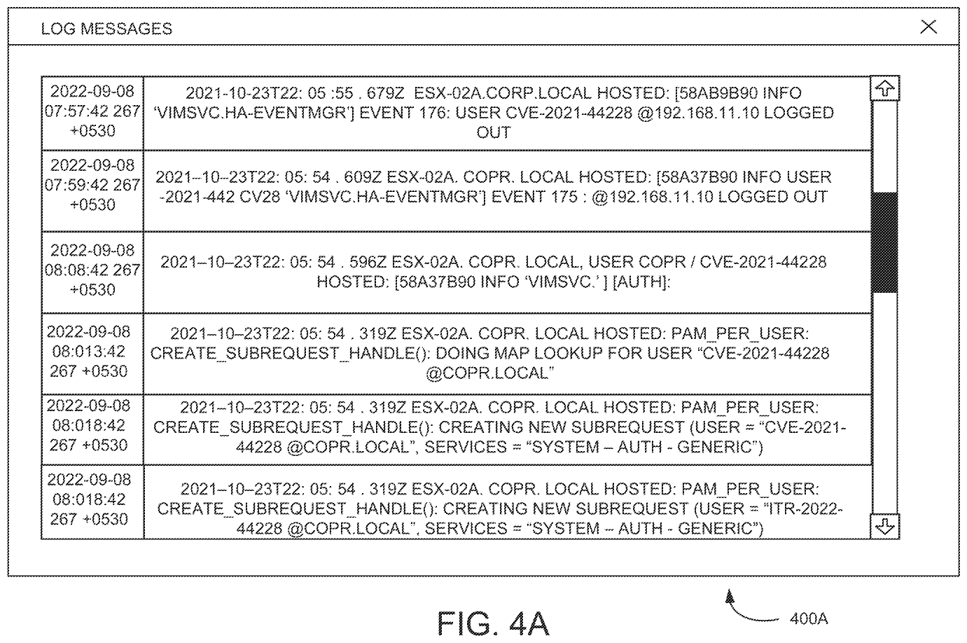

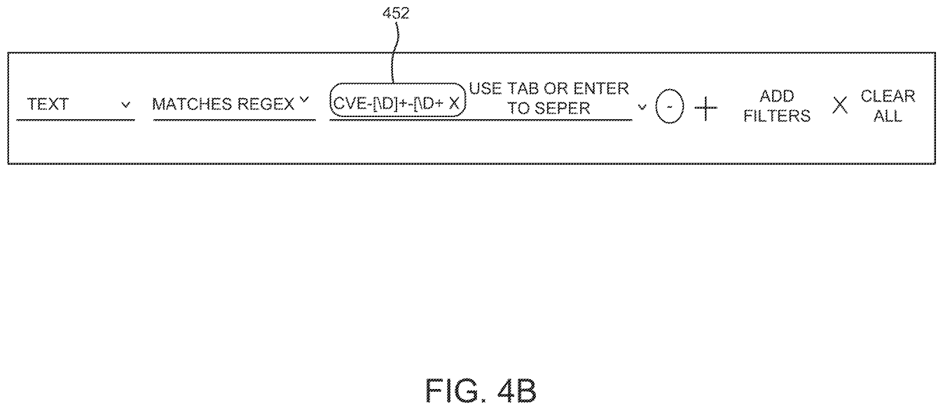

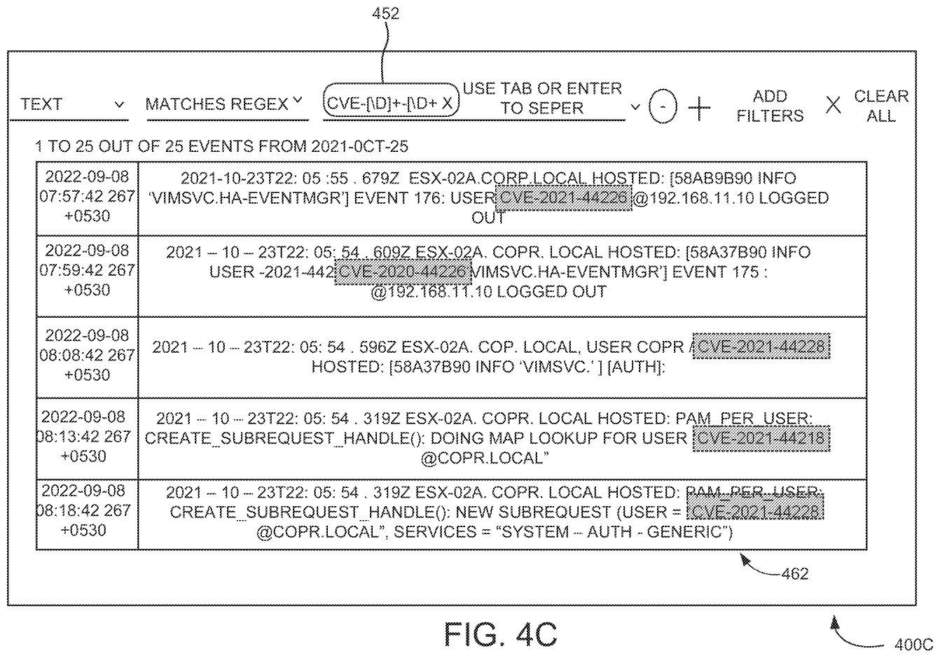

During operation, discovery service 108 may receive, during runtime, a plurality of logs associated with a plurality of applications or operating systems running in the computing environment from log database 114. In an example, a log may be a file including information about events that have occurred within an application or an operating system of a compute node (e.g., compute node 118A). These events are logged out by the application or the operating system and written to the file. Further, such files may be stored in log database 114. The log can include errors and warnings as well as informational events. Example logs are depicted in FIG. 4A.

Further, discovery service 108 may extract a vulnerability signature of an attack based on the plurality of logs. The vulnerability signature can refer to an attack pattern that is indicative of a threat or attack intended to exploit the vulnerability in the computer program. In an example, discovery service 108 may determine logs including the vulnerability signature by running a query including a regular expression on log database 114 and extract the vulnerability signature by parsing the determined logs using the regular expression. For example, the regular expression can be a sequence of characters that defines a search pattern. Regular expressions are a generalized way to match patterns with sequences of characters. Such a regular expression can be used by a search algorithm (e.g., string searching algorithm) for performing one or more operations on strings (e.g., find operation). An example regular expression is depicted in FIG. 4B.

Further, validation service 110 may validate the vulnerability signature of the attack by correlating the vulnerability signature with available data on public database 116. Example public database 116 may be a common vulnerabilities and exposures (CVE) database, which includes a list of publicly disclosed computer security flaws (i.e., known attack patterns). In such databases, each security flaw may be assigned a CVE identifier. Upon validating the vulnerability signature, validation service 110 may retrieve vulnerability information associated with the vulnerability signature from public database 116 or another public database. In an example, validation service 110 may retrieve the vulnerability information using the CVE identifier.

In an example, validation service 110 may transmit a first hypertext transfer protocol (HTTP) get command to a first web server that includes public database 116 to retrieve the available data including defined vulnerability signatures. In response to transmitting the first HTTP get command, validation service 110 may receive the available data including the defined vulnerability signatures from the first web server. Further, validation service 110 may validate the vulnerability signature of the attack by matching the extracted vulnerability signature with the defined vulnerability signatures.

Further, upon validating the vulnerability signature, validation service 110 may transmit a second HTTP get command to the web server or a second web server that includes the other public database. In response to transmitting the second HTTP get command, validation service 110 may receive the vulnerability information associated with the vulnerability signature from the first web server or the second webserver.

Further, security insight service 112 may generate an insight by curating the vulnerability information associated with the vulnerability signature. Further, security insight service 112 may present the insight on a graphical user device. In an example, security insight service 112 may recommend an action to be performed to mitigate a security vulnerability related to the attack based on the vulnerability information.

FIG. 1B is a block diagram of example computing environment 100 of FIG. 1A, depicting additional features. Similarly named elements of FIG. 1B may be similar in structure and/or function to elements described in FIG. 1A. As shown in FIG. 1B, example computing environment 100 includes a user device 152 and a storage device 156. Further, log management server 102 may be communicatively connected to a public database 154 that is different public database 116.

During operation, validation service 110 may validate the vulnerability signature by correlating the vulnerability signature with available data on public database 154. Upon validating the vulnerability signature against public database 116 and public database 154, validation service 110 may retrieve the vulnerability information associated with the vulnerability signature from public database 116 and/or public database 154.

In some examples, public database 116 and public database 154 may be maintained by the Software Engineering Institute at Carnegie Mellon University of Pittsburgh, Pa., a CVE scheme maintained by MITRE Corporation of Bedford, Mass., the Bugtraq vulnerability list maintained by Security Focus of SYMANTEC CORPORATION of Mountain View, Calif. Various entities, corporations, or software firms may also maintain public vulnerabilities registries regarding the products they develop in relevant web sites. In an example, validation service 110 can be configured to receive, access, look up, process, analyze or otherwise obtain and utilize information of one or more vulnerabilities lists or registries in one or more formats, standards, or schemes. For example, validation service 110 can be configured to use the CVE vulnerability scheme created by MITRE Corporation. Example public database 116 may be “CVE Details” database and public database 154 may be “CIRCL CVE Search” database.

Further, validation service 110 may store the vulnerability information associated with the vulnerability signature in storage device 156 (i.e., a local datastore). Upon receiving a request from user device 152, validation service 110 may query storage device 156 (i.e., the local datastore) to obtain the vulnerability information including a recommended action to mitigate a security vulnerability related to the attack on the application or the operating system. Furthermore, security insight service 112 may present the obtained vulnerability information including the recommended action in an analytics dashboard of the graphical user interface of user device 152.

In some examples, the functionalities described in FIGS. 1A and 1B, in relation to instructions to implement functions of discovery service 108, validation service 110, security insight service 112, and any additional instructions described herein in relation to the storage medium, may be implemented as engines or modules including any combination of hardware and programming to implement the functionalities of the modules or engines described herein. The functions of discovery service 108, validation service 110, and security insight service 112 may also be implemented by a processor. In examples described herein, the processor may include, for example, one processor or multiple processors included in a single device or distributed across multiple devices. In an example, examples described herein may be implemented in a log analysis tool that provides operational visibility. An example log analysis tool may be VMware's Log Intelligence (also known as vRealize Log Insight Cloud), VMware's cloud monitoring platform. The log analysis tool described herein may be provided as a security insight feature, which facilitates users to view the security vulnerabilities present in the compute nodes in no time. Thus, the user may be able to figure out their products and applications which are currently vulnerable and which part of system is affected by the vulnerabilities. Further, examples described herein may also present a detailed explanation about the vulnerability to help the users to understand the vulnerability. Furthermore, the recommendation may suggest a set of actions users need to perform in other to get rid of these vulnerabilities and secure their applications.

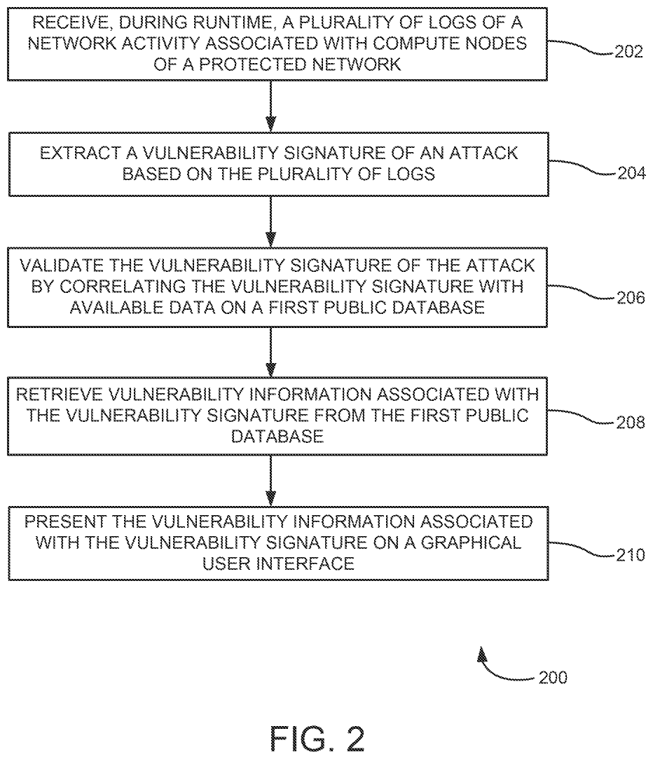

FIG. 2 is a flow diagram illustrating an example computer-implemented method 200 for detecting vulnerabilities in compute nodes of a protected network. The process depicted in FIG. 2 represents generalized illustrations, and other processes may be added, or existing processes may be removed, modified, or rearranged without departing from the scope and spirit of the present application. In addition, the process may represent instructions stored on a computer-readable storage medium that, when executed, may cause a processor to respond, to perform actions, to change states, and/or to make decisions. Alternatively, the process may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 202, a plurality of logs of a network activity associated with compute nodes of the protected network may be received during runtime. In an example, the plurality of logs of the network activity may be received for a time period during runtime. For example, the time period can be daily, weekly, monthly, hourly, every 12 hours, or some other time interval specified by a system administrator or in a configuration file. An example log is depicted in FIG. 4A.

At 204, a vulnerability signature of an attack may be extracted based on the plurality of logs. In an example, extracting the vulnerability signature of the attack may include filtering the plurality of logs using a regular expression to determine logs including the vulnerability signature. Further, the vulnerability signature that matches the regular expression may be extracted from the filtered logs.

At 206, the vulnerability signature of the attack may be validated by correlating the vulnerability signature with available data on a first public database. In an example, validating the vulnerability signature of the attack includes transmitting a first hypertext transfer protocol (HTTP) get command to a first web server that includes the first public database to retrieve the available data including defined vulnerability signatures. Further, a first response to the first HTTP get command may be received from the first web server. The first response may include the defined vulnerability signatures. Furthermore, the vulnerability signature of the attack may be validated by matching the extracted vulnerability signature with the defined vulnerability signatures.

At 208, upon validating the vulnerability signature, vulnerability information associated with the vulnerability signature may be retrieved from the first public database or a second public database. In an example, retrieving the vulnerability information includes:
upon validating the vulnerability signature, transmitting a second HTTP get command to the first web server or a second web server that includes the second public database, and
receiving a second response to the second HTTP get command from the first web server or the second web server. The second response may include the vulnerability information associated with the vulnerability signature.

In some examples, the vulnerability signature of the attack may be validated by correlating the vulnerability signature with available data on a second public database. Upon validating the vulnerability signature against the first public database and the second public database, the vulnerability information associated with the vulnerability signature may be retrieved from the first public database and the second public database. In an example, the vulnerability information may be associated with an application or an operating system running on a compute node in the protected network.

At 210, the vulnerability information associated with the vulnerability signature may be presented on a graphical user interface. Further, the vulnerability information associated with the vulnerability signature may be stored in a storage device. In an example, in response to receiving a request, the storage device may be queried to obtain the vulnerability information including a recommended action to mitigate a security vulnerability related to the attack on an application or an operating system. Further, the obtained vulnerability information including the recommended action may be presented in an analytics dashboard of the graphical user interface.

In an example, an insight may be generated based on the vulnerability information associated with the vulnerability signature. Further, the insight may be presented to a user via the graphical user device. For example, generating the insight includes at least one of:
categorising security vulnerabilities related to the attack based on a type, a severity level, or both associated with the attack,
providing an application-level visibility, a host-level visibility, or both associated with the attack,
recommending an action to be performed to mitigate a security vulnerability related to the attack,
classifying a severity of the attack based on a vulnerability score, and
exploring an access exploitation and an impact of the security vulnerabilities.

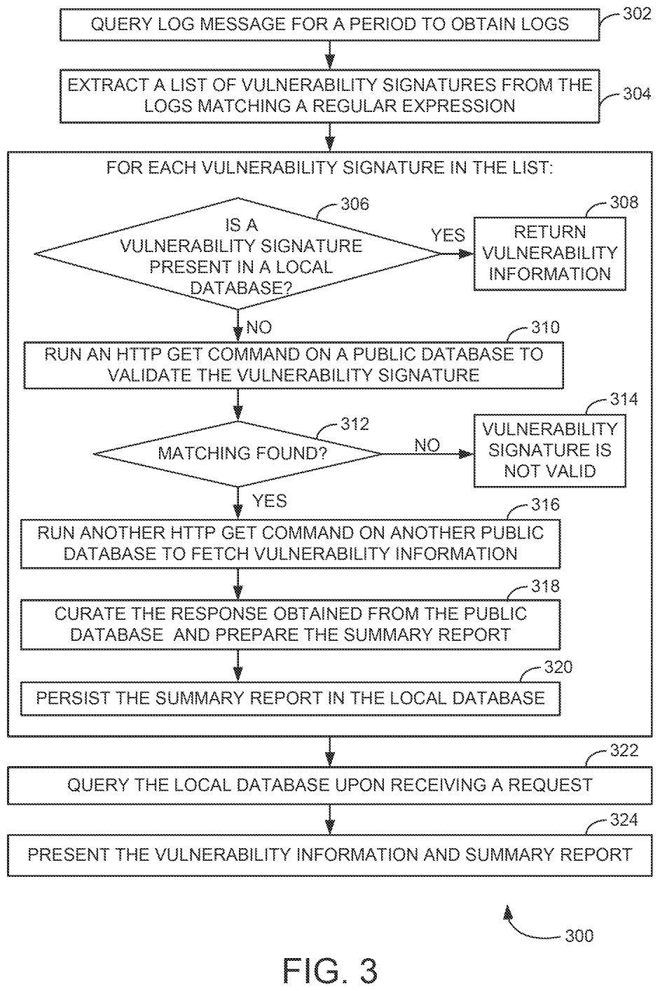

FIG. 3 is a flow diagram illustrating another example method 300 for detecting security vulnerabilities in compute nodes. At 302, log messages or logs may be queried for a period (e.g., a period of one day assuming schedulers run once every day). Example log messages corresponding to the period are depicted in a graphical user interface 400A of FIG. 4A. Referring back to FIG. 3, at 304, a list of vulnerability signatures associated with an attack may be extracted from the plurality of logs. For example, CVE signatures may be extracted from all the logs matching a regular expression. The regular expression can be used to extract a substring of a data from a data set when that substring has the form expressed in the regular expression. An example regular expression is depicted in FIG. 4B. For example, the regular expression may be “CVE−[\d]+−[\d]+x” (e.g., 452). Thus, the logs are filtered out corresponding to the security vulnerabilities. For example, the logs corresponding to the security vulnerabilities may include a CVE record that follows a standard format as defined by a MITRE numbering authority, a non-profit organisation which defines a security number for all sort of vulnerabilities worldwide. These logs are identified and filtered using a specific regular expression to detect CVE records in the logs.

In an example, log identification can be done by running a scheduled job which runs a query that can identify the logs with security signature. The query may include a particular regular expression which can be used in cloud monitoring tools (e.g., vRealize Log Insight Cloud) as shown in FIG. 4B. Further, the query may return a set of logs which includes the CVE vulnerability codes which can be used to extract vulnerability details from public available data sources (e.g., public database 116 and second public database 154). The filtered logs (e.g., 462) of the above query can be found in FIG. 4C. FIG. 4C depicts a graphical user interface 400C, depicting an example list of filtered logs including the vulnerability signatures. In the example shown in FIG. 4C, the vulnerability signatures are annotated or highlighted in the filtered logs (e.g., 462).

Referring back to FIG. 3, processes at blocks 306 to 320 may be repeated for each vulnerability signature in the list of vulnerability signatures to validate the vulnerability signatures and fetch vulnerability information associated with the validated vulnerability signatures. At 306, a check is made to validate a vulnerability signature in the list of vulnerability signatures by correlating the vulnerability signature with available data on a local database. When the vulnerability signature is present in the local database, at 308, the vulnerability information corresponding to the vulnerability signature is extracted from the local database and returned to a user via a graphical user interface.

When the vulnerability signature is not present in the local database, at 310, the vulnerability signature may be correlated with available data on a first public database. In this example, an HTTP GET command may be executed on the first public database (e.g., a CVE database by MITRE). At 312, a check is made to determine if a result for the vulnerability signature is found in the first public database. When the result is not found in the first public database, at 314, the vulnerability signature is determined as not valid (i.e., do not correspond to the one or more signatures of the attacks configured to exploit the one or more current vulnerabilities).

When the result is found in the first public database, at 316, the vulnerability signature (i.e., CVE code) is considered valid. In this example, another HTTP GET command may be executed to fetch the vulnerability information about vulnerabilities from another public database (e.g., a CVE search database).

In an example, the validation of the vulnerability signature may be performed in a two-fold task of fetching the CVE signatures from public sources/databases and matching the extracted CVE signature against data available in the public sources. Although the possibility of finding outliers in the logs that follow the same format is low, the examples described herein may perform validation by checking the CVE identifier against two publicly available sources (i.e., the CVE Details and CIRCL CVE Search). Further, the security vulnerability is considered as valid when the extracted signature is present in both the public databases. Further, various types of security attributes like the CVS score, access, impact, type, and the like may be discovered for the valid vulnerability signatures.

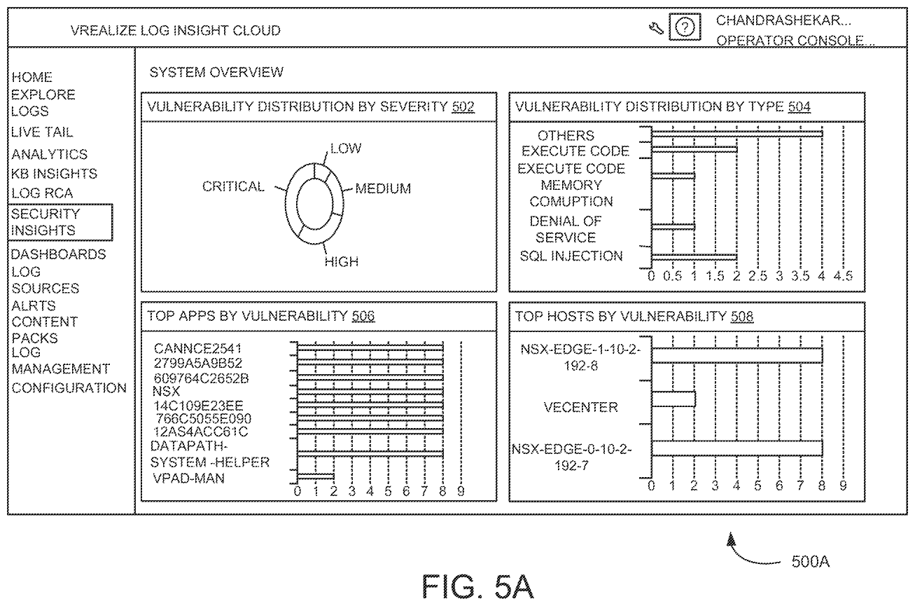

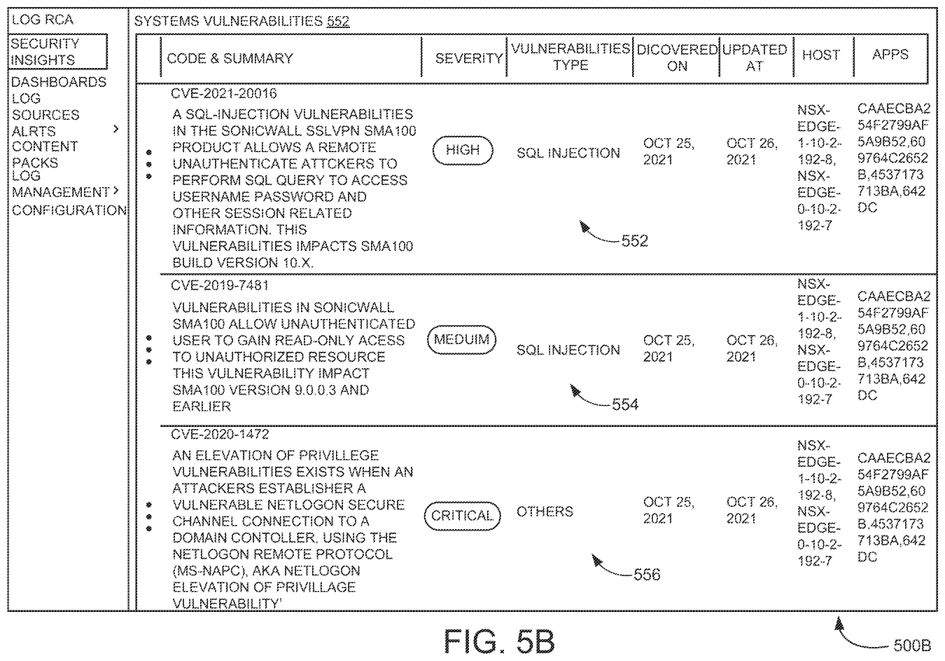

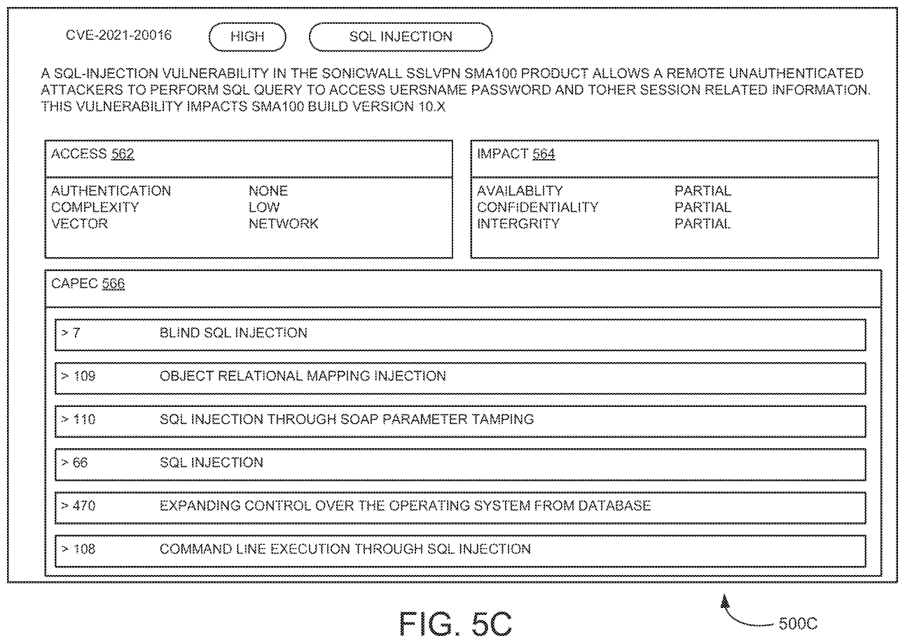

At 318, the response obtained from the previous step may be curated and a summary report including the vulnerability information may be presented, which may impact surfaces and actions to fix the security vulnerabilities. At 320, the vulnerability information along with the summary report may be persisted on the local database. An example summary report is depicted in FIGS. 5A, 5B, and 5C.

At 322, upon receiving a request corresponding to any vulnerability in the list of vulnerabilities from the user (e.g., via the graphical user interface), the local database may be queried to retrieve the vulnerability information from the local database. At 324, the vulnerability information may be presented on the graphical user interface via an analytics dashboard.

FIG. 5A is an example graphical user interface 500A depicting vulnerability by severity and type. For example, FIG. 5A depicts graphical user interface 500A graphically displaying vulnerability distribution by severity 502, vulnerability distribution by type 504, top applications by vulnerability 506, top hosts by vulnerability 508.

FIG. 5B is another example graphical user interface 500B depicting CVE details for various system vulnerabilities (e.g., 552). For example, FIG. 5B depicts graphical user interface 500B displaying insights of vulnerability information “CVE details” such as CVE-2021-20016 (e.g., 552), CVE-2019-7481 (e.g., 554), and CVE-2020-1472 (e.g., 556) corresponding to the system vulnerabilities.

FIG. 5C is yet another example graphical user interface 500C depicting access exploitation (e.g., 562) and impact (e.g., 564) of vulnerabilities along with potential fixes (e.g., 566). Thus, graphical user interface 500C of FIG. 5C provides an option to explore the access exploitation and impact of the vulnerabilities along with potential fixes (i.e., potential solutions to mitigate the security vulnerabilities related to the attack). Thus, examples described herein provides the graphical user interfaces to depict visualisation of the detected vulnerabilities in a single pane of glass.

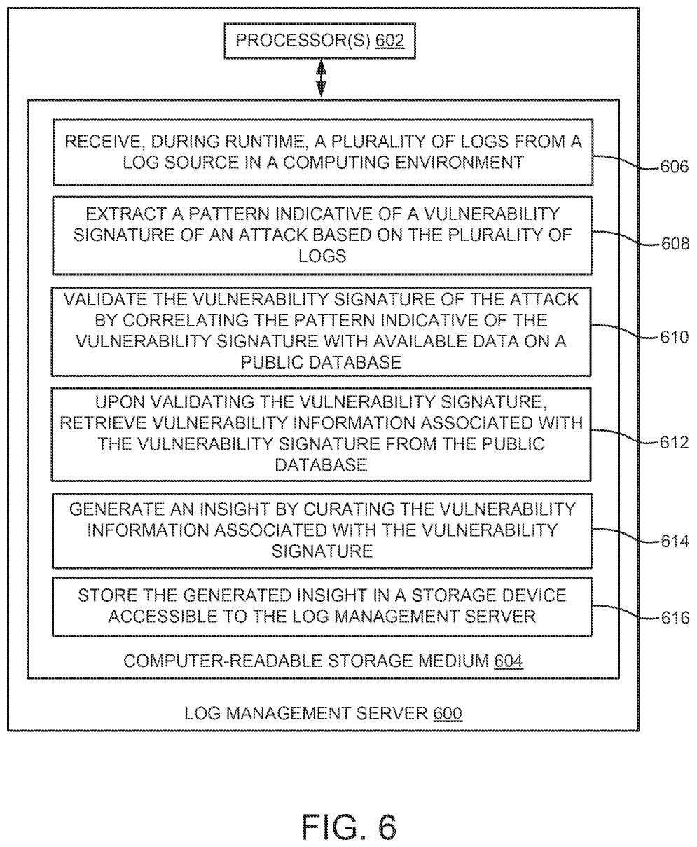

FIG. 6 is a block diagram of an example log management server 600 including non-transitory computer-readable storage medium 604 storing instructions to detect vulnerabilities in a computing environment. Log management server 600 may include a processor 602 and computer-readable storage medium 604 communicatively coupled through a system bus. Processor 602 may be any type of central processing unit (CPU), microprocessor, or processing logic that interprets and executes computer-readable instructions stored in computer-readable storage medium 604. Computer-readable storage medium 604 may be a random-access memory (RAM) or another type of dynamic storage device that may store information and computer-readable instructions that may be executed by processor 602. For example, computer-readable storage medium 604 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 604 may be a non-transitory computer-readable medium. In an example, computer-readable storage medium 604 may be remote but accessible to log management server 600.

Computer-readable storage medium 604 may store instructions 606, 608, 610, 612, 614, and 616. Instructions 606 may be executed by processor 602 to receive, during runtime, a plurality of logs from a log database in a computing environment. Instructions 608 may be executed by processor 602 to extract a pattern indicative of a vulnerability signature of an attack based on the plurality of logs. In an example, instructions 608 to extract the pattern indicative of the vulnerability signature may include instructions to:
execute a scheduled job including a query on the log database to determine logs including the vulnerability signature corresponding to a time period, wherein the query includes a regular expression, and
extract the pattern indicative of the vulnerability signature that matches the regular expression from the determined logs.

Instructions 610 may be executed by processor 602 to validate the vulnerability signature of the attack by correlating the pattern indicative of the vulnerability signature with available data on a public database. In an example, instructions 610 to validate the vulnerability signature of the attack may include instructions to:
transmit a hypertext transfer protocol (HTTP) get command to a web server that includes the public database to retrieve the available data including defined vulnerability signatures,
receive a response to the HTTP get command from the web server, the response including the defined vulnerability signatures, and
validate the vulnerability signature of the attack by matching the extracted vulnerability signature with the defined vulnerability signatures.

Instructions 612 may be executed by processor 602 to retrieve vulnerability information associated with the vulnerability signature from the public database upon validating the vulnerability signature. Instructions 614 may be executed by processor 602 to generate an insight by curating the vulnerability information associated with the vulnerability signature. Instructions 616 may be executed by processor 602 to store the generated insight in a storage device accessible to log management server 600.

Further, computer-readable storage medium 604 may store instructions to query the storage device to obtain the vulnerability information including a recommended action to mitigate a security vulnerability related to the attack on an application or an operating system in response to receiving a request. Further, instructions may be executed by processor 602 to present the obtained vulnerability information including the recommended action in an analytics dashboard of a graphical user interface.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
receiving, during runtime, a plurality of logs of a network activity associated with compute nodes of a protected network;
extracting a vulnerability signature of an attack based on the plurality of logs;
validating the vulnerability signature of the attack by correlating the vulnerability signature with available data on a first public database;
upon validating the vulnerability signature, retrieving vulnerability information associated with the vulnerability signature from the first public database or a second public database; and
presenting the vulnerability information associated with the vulnerability signature on a graphical user interface.

2. The method of claim 1, wherein extracting the vulnerability signature of the attack comprises:
filtering the plurality of logs using a regular expression to determine logs including the vulnerability signature; and
extracting the vulnerability signature that matches the regular expression from the filtered logs.

3. The method of claim 1, further comprising:
generating an insight based on the vulnerability information associated with the vulnerability signature; and
presenting the insight to a user via the graphical user device.

4. The method of claim 3, wherein generating the insight comprises at least one of:
categorising security vulnerabilities related to the attack based on a type, a severity level, or both associated with the attack;
providing an application-level visibility, a host-level visibility, or both associated with the attack;
recommending an action to be performed to mitigate a security vulnerability related to the attack;
classifying a severity of the attack based on a vulnerability score; and
exploring an access exploitation and an impact of the security vulnerabilities.

5. The method of claim 1, wherein validating the vulnerability signature of the attack comprises:
transmitting a first hypertext transfer protocol (HTTP) get command to a first web server that includes the first public database to retrieve the available data including defined vulnerability signatures;
receiving a first response to the first HTTP get command from the first web server, the first response including the defined vulnerability signatures; and
validating the vulnerability signature of the attack by matching the extracted vulnerability signature with the defined vulnerability signatures.

6. The method of claim 5, wherein retrieving the vulnerability information comprises:
upon validating the vulnerability signature, transmitting a second HTTP get command to the first web server or a second web server including a second public database; and
receiving a second response to the second HTTP get command from the first web server or the second web server, the second response including the vulnerability information associated with the vulnerability signature.

7. The method of claim 1, further comprising:
validating the vulnerability signature of the attack by correlating the vulnerability signature with available data on the second public database; and
upon validating the vulnerability signature against the first public database and the second public database, retrieving the vulnerability information associated with the vulnerability signature from the first public database and the second public database.

8. The method of claim 1, further comprising:
storing the vulnerability information associated with the vulnerability signature in a storage device.

9. The method of claim 8, further comprising:
in response to receiving a request, querying the storage device to obtain the vulnerability information including a recommended action to mitigate a security vulnerability related to the attack on an application or an operating system; and
presenting the obtained vulnerability information including the recommended action in an analytics dashboard of the graphical user interface.

10. The method of claim 1, wherein the vulnerability information is associated with an application or an operating system running on a compute node in the protected network.

11. The method of claim 1, wherein receiving, during runtime, the plurality of logs of the network activity comprises:
receiving, during runtime, the plurality of logs of the network activity for a time period.

12. A log management server comprising:
a processor; and
memory coupled to the processor, wherein the memory comprises:
a discovery service to:
receive, during runtime, a plurality of logs associated with a plurality of applications or operating systems running in a computing environment from a log database; and
extract a vulnerability signature of an attack based on the plurality of logs;
a validation service to:
validate the vulnerability signature of the attack by correlating the vulnerability signature with available data on a public database; and
upon validating the vulnerability signature, retrieve vulnerability information associated with the vulnerability signature from the public database or another public database; and
a security insight service to:
generate an insight by curating the vulnerability information associated with the vulnerability signature; and
present the insight on a graphical user device.

13. The log management server of claim 12, wherein the discovery service is to:
determine logs including the vulnerability signature by running a query including a regular expression on the log database; and
extract the vulnerability signature by parsing the determined logs using the regular expression.

14. The log management server of claim 12, wherein the security insight service is to:
recommend an action to be performed to mitigate a security vulnerability related to the attack based on the vulnerability information.

15. The log management server of claim 12, wherein the validation service is to:
transmit a first hypertext transfer protocol (HTTP) get command to a first web server that includes the public database to retrieve the available data including defined vulnerability signatures;
in response to transmitting the first HTTP get command, receive the available data including the defined vulnerability signatures from the first web server; and
validate the vulnerability signature of the attack by matching the extracted vulnerability signature with the defined vulnerability signatures.

16. The log management server of claim 15, wherein the validation service is to:
upon validating the vulnerability signature, transmit a second HTTP get command to the first web server or a second web server that includes the other public database; and
in response to transmitting the second HTTP get command, receive the vulnerability information associated with the vulnerability signature from the first web server or the second webserver.

17. A non-transitory computer-readable storage medium encoded with instructions that, when executed by a processor of a log management server, cause the processor to:
receive, during runtime, a plurality of logs from a log database in a computing environment;
extract a pattern indicative of a vulnerability signature of an attack based on the plurality of logs;
validate the vulnerability signature of the attack by correlating the pattern indicative of the vulnerability signature with available data on a public database;
upon validating the vulnerability signature, retrieve vulnerability information associated with the vulnerability signature from the public database;
generate an insight by curating the vulnerability information associated with the vulnerability signature; and
store the generated insight in a storage device accessible to the log management server.

18. The non-transitory computer-readable storage medium of claim 17, further comprising instructions to:
in response to receiving a request, query the storage device to obtain the vulnerability information including a recommended action to mitigate a security vulnerability related to the attack on an application or an operating system; and
present the obtained vulnerability information including the recommended action in an analytics dashboard of a graphical user interface.

19. The non-transitory computer-readable storage medium of claim 17, wherein instructions to extract the pattern indicative of the vulnerability signature comprise instructions to:
execute a scheduled job including a query on the log database to determine logs including the vulnerability signature corresponding to a time period, wherein the query includes a regular expression; and
extract the pattern indicative of the vulnerability signature that matches the regular expression from the determined logs.

20. The non-transitory computer-readable storage medium of claim 17, wherein instructions to validate the vulnerability signature of the attack comprises instructions to:
transmit a hypertext transfer protocol (HTTP) get command to a web server that includes the public database to retrieve the available data including defined vulnerability signatures;
receive a response to the HTTP get command from the web server, the response including the defined vulnerability signatures; and
validate the vulnerability signature of the attack by matching the extracted vulnerability signature with the defined vulnerability signatures.
